(19) United States
(12) Patent Application Publication
(10) Pub. No.: US 2026/0073276 A1
(43) Pub. Date: Mar. 12, 2026

(54) METHOD AND SYSTEM FOR AUGMENTING MACHINE-LEARNING MODELS FOR INTERACTIVE MEDIA GENERATION

(71) Applicant: Global Publishing Interactive, Inc., Troy, OH (US)

(72) Inventor: Robert Hoffer, Miami Beach, FL (US)

(21) Appl. No.: 18/827,257

(22) Filed: Sep. 6, 2024

(51) Int. Cl. G06N 20/00; H04N 21/8545

(52) U.S. Cl. CPC G06N 20/00; H04N 21/8545

(57) ABSTRACT

A computing device may receive interaction data characterizing an interaction between a client device and a media element. The computing device may generate a training dataset using the interaction dataset and characteristics associated with the client device. A machine-learning model may execute using a feature vector derived from the training dataset. The machine-learning model defines a context associated with the interaction with the media element and generates an interaction response based on the context. The interaction response may be presented by the client device. Upon receiving subsequent interaction data associated with the interaction response may cause the machine-learning model to define a new context associated with the subsequent interaction data and the interaction response. The computing device may update the update the training dataset using the new context. The updated training dataset can cause a subsequent execution of the machine-learning model to generate modified media elements.

### TECHNICAL FIELD

This disclosure relates generally to machine-learning models for generating media, and more particularly to augmenting machine-learning model generating various types of customized media.

### BACKGROUND

Media is often generated and presented in static representations. For example, media may be presented via a webpage within a frame or a media player. Certain parameters may be defined to govern the presentation such as the layout, presentation duration, volume, etc., but the parameters are defined in advanced when the media is received. In some instances, media can be configured to provide an illusion of interactivity to make the presentation appear more dynamic. For instance, the media may include instructions that cause a selection to cause a predetermined function to execute such as executing a link to a webpage or a modification to the presentation of the media, etc.

### SUMMARY

Methods are described herein for augmenting machine-learning models for interactive media. receiving interaction data associated with a media segment, wherein the interaction data characterizes an instance of a client device interacted with the media segment; generating a training dataset using the interaction data, wherein the training dataset is augmented with characteristics associated with a user identifier associated with the client device; executing a machine-learning model using a feature vector derived from the training dataset, wherein the machine-learning model defines a context associated with the instance of user interaction with the media segment and generates an interaction response based on the context, and wherein the interaction response is contextually related to the media segment; facilitating a presentation of the interaction response; receiving new interaction data associated with the interaction response, wherein the new interaction data includes an instance of user interaction with the interaction response; executing the machine-learning model using the training dataset and the new interaction data, wherein the machine-learning model defines a new context associated with the instance of user interaction with the interaction response; and updating the training dataset using the new context, wherein updating the training data causes a subsequent execution of the machine-learning model to generate a modified media segment

The systems described herein for augmenting machine-learning models for interactive media. The systems may include one or more processors and a non-transitory computer-readable medium storing instructions that, when executed by the one or more processors, cause the one or more processors to perform any of the methods as previously described.

The non-transitory computer-readable media described herein may store instructions which, when executed by one or more processors, cause the one or more processors to perform any of the methods as previously described.

These illustrative examples are mentioned not to limit or define the disclosure, but to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 illustrates a block diagram of an example media generation system that augments machine-learning models to generate interactive media according to aspects of the present disclosure.

FIG. 2 illustrates a block diagram of an example process of generating interactive media for according to aspects of the present disclosure.

FIG. 3 illustrates a block diagram of an example media generation system configured to generate interactive media using augment machine-learning models according to aspects of the present disclosure.

FIG. 4 illustrates a block diagram of an example distributed media generation system configured to generate interactive media using augment machine-learning models according to aspects of the present disclosure.

FIG. 5 illustrates a flowchart of an example process for augmenting machine-learning models for interactive media according to aspects of the present disclosure.

FIG. 6 illustrates an example computing device architecture of an example computing device that can implement the various techniques described herein according to aspects of the present disclosure.

### DETAILED DESCRIPTION

Methods and systems are described herein for augmenting machine-learning models for interactive media. Some media is generated using static configurations (e.g., static layouts, size, resolution, duration of presentation, etc.). Machine-learning models can be configured to dynamically generate media (e.g., strings, images, audio, video, video games, combinations thereof, and/or the like) at runtime. The machine-learning models are trained using very large datasets including various types of media. While this training methodology enables generating disparate types of media at runtime, the trained machine-learning models are not flexible when generating specific types of media for specific users or user groups. The methods and systems described herein include augmented machine-learning models configured to dynamically (e.g., at runtime) generate interactive media for particular users and user groups. The augmented machine-learning models can generate and modify media of any type in real time to adapt to input received from users. In some examples, the machine-learning model may generate media that is interactive (e.g., responds to and/or changes based on input received from a user and information associated with the user) and/or modify static media to be interactive (e.g., such as modifying an image into a moving graphic such as a graphics interchange format (GIF) or a video, adding synthetic audio such as a narrator or character voice, replacing the media with related media such as a subsequent image of a comic book or story, presenting a communication generated by the machine-learning model, creating graphics, etc.).

A user interface (e.g., of a website, application, etc.) may include one or more media elements (e.g., static media such as text or images, dynamic media such as audio and/or video, interactive media such as media that may change in response to detecting input or sensor data, combinations thereof, and/or the like. Each media element (and/or the user interface) may include an event listener. The event listener may generate event in response to detecting particular activity associated with the user interface. Examples of activity associated with the user interface include, but is not limited to, expiration of a timer, detecting user input, detecting a communication from a remote device, detecting an interrupt, detecting sensor input, combinations thereof, and/or the like). The event may include an identification of the particular activity and a payload (e.g., information associated with the timer, the input from the user input, the sensor data, information associated with the interrupt, the contents of the communications and/or information associated with a source of the communication received from the remote device, combinations thereof, and/or the like).

Upon detecting an event, the user interface may generate a context dataset. The context dataset may include, but is not limited to, an identification of the media element, an identification of an event that triggered the communication, in identification of the user interface, an identification of a device executing the user interface, a user identifier associated with a user that executed the user interface or that is operating the user interface, information associated with the user identifier and/or the user (e.g., such as a name, demographic information, location information, etc.), an identification of a user profile associated with the user identifier, device information (e.g., such as, but not limited to, software installed on the device, hardware installed in the device, processing capabilities of the device, a current processing load of the device, etc.), network information (e.g., such as an Internet Protocol address of the device, a media access control address, available network bandwidth, a maximum network bandwidth, an internet service provider of the device, an identification of available network interface and/or radios of the device, etc.), an identification of user interactions with the user interface or the media element (e.g., such as, but not limited to, information associated with user interaction with the user interface, websites, applications, combinations thereof, and/or the like), an identification of recent user interactions with the user interface or the media element (e.g., user interactions occurring within the current session of the user interface, user interactions occurring within a previous time interval, etc.) combinations thereof, and/or the like. Alternatively, the context dataset may already be generated and associated with a user profile associated with the user. The context dataset may be updated each time the user interacts with the user interface and each time the event listener generates an event.

The user interface may then transmit a communication to a machine-learning node. The machine-learning node may be a component of the device executing the user interface (e.g., the device operated by the user). Alternatively, the machine-learning node may be a component of a host of the user interface (e.g., such as a webhost, content delivery network, cloud network, server, etc.), a component of a remote device configured to execute machine-learning tasks, and/or the like. The communication may include the event, an identification of the media element associated with the event, instructions (e.g., application programming interface functions, remote procedure calls, etc.) to invoke operations of the machine-learning node, the context dataset, and/or the like.

The machine-learning node may include one or more machine-learning models configured to generate instructions to modify the media element based on the context dataset. In some instances, machine-learning node may include a group of machine-learning models configured to predict a context associated with the event relative to the particular user operating the user interface and generate the instructions to modify the media element based in part on the predicted context. Examples of machine-learning models that may be included in ML models 140 include, but are not limited to, neural networks (e.g., such as recurrent neural networks, long short-term memory (LSTM), mask recurrent neural networks, convolutional neural networks, faster convolutional neural networks, etc.), deep learning networks, you only look once (YOLO), EfficientDet, deep learning networks, transformers (generative pre-trained transformers (GPT), Bidirectional Encoder Representations from Transformers (BERTs), text-to-text-transfer-transformer (T5), or the like), generative adversarial networks (GANs), recurrent gated units (GRUs), combinations thereof, or the like.

In some instances, the machine-learning node may be managed by a data controller that is associated with the user interface. In those instances, the data controller may have access to the user interface and data associated with the user (e.g., such as a user profile associated with the user, the context dataset and/or any data thereof, etc.). The data controller can facilitate training of the one or more machine-learning models using data associated with the user (e.g., such as, but not limited to the context dataset, etc.) and/or data associated with similar users (e.g., based on a correspondence between the context dataset associated with the user and context dataset associated with other users). The one or more machine-learning models may be trained using supervised learning, unsupervised learning, semi-supervised learning, transfer learning, metalearning, reinforcement learning, combinations thereof, or the like. The one or more machine-learning models may be trained for a predetermined time interval, predetermined quantity of iterations, and/or until the one or more accuracy metrics are reached (e.g., such as, but not limited to, accuracy, precision, area under the curve, logarithmic loss, F1 score, a longest common subsequence (LCS) such as ROUGE-L, Bilingual evaluation Understudy (BLEU) mean absolute error, mean square error, or the like). Since the one or more machine-learning models may be trained using data associated with the user (and/or similar users), the one or more machine-learning models may be configured to generate an output that is tailored to the particular user.

In other instances, the machine-learning node may be independent from the user interface (e.g., operated by a separate entity, operated within a distinct environment, etc.). In those instances, the one or more machine-learning models may not have access to the data associated with the user to tailor the training of the one or more machine-learning models. Instead, the one or more machine-learning models may be trained using generic or user agnostic training data. The training data may be derived from a large, diversified source to enable general training of the one or more machine-learning models. The one or more machine-learning models may be trained using supervised learning, unsupervised learning, semi-supervised learning, transfer learning, metalearning, reinforcement learning, combinations thereof, or the like. The one or more machine-learning models may be trained for a predetermined time interval, predetermined quantity of iterations, and/or until the one or more accuracy metrics are reached (e.g., such as, but not limited to, accuracy, precision, area under the curve, logarithmic loss, F1 score, a longest common subsequence (LCS) such as ROUGE-L, Bilingual evaluation Understudy (BLEU) mean absolute error, mean square error, or the like).

The input to the one or more machine-learning models may be modified to bias the weights of the one or more machine-learning models to generate outputs tailored to particular users in a similar or same manner as if the one or more machine-learning models were trained using data associated with the particular users. In The user interface and/or the machine-learning node may be configured use the event and the context dataset to generate a feature vector for the one or more machine-learning models. In some instances, the feature vector may be modified by injecting a data structure generated from the context dataset at a particular location of the feature vector. For instance, the data structure may be injected before other features of the feature vector or after the other features of the feature vector. Alternatively, the data structure may be segmented and portions of the data structure may be inserted at one or more locations with the feature vector. The one or more locations may be based on a feature type of features of the feature vector and/or feature values of features of the feature vector. For instance, a portion of the data structure may be inserted before or after features associated with user activity to cause the one or more machine-learning models to weight the features associated with user activity higher than if the portion of the data structure was not inserted.

The machine-learning model may output instructions that cause a modification to the media element based on the event and the context dataset. The modification may include instructions that modify the media element to cause a response to the event that is tailored to the user. The modification may cause the media element to become interactive. For example, the media element may be an image associated with product or service. The user interface may generate an event when a cursor is positioned over a portion of the image. The machine-learning model may generate a modification to the media element that includes a modified version of the image (e.g., wherein the modified version of the image includes a new image associated with the image, a modification to the portion of the image, etc.). For instance, the modified version of the image may include additional information associated with the product or service, information retrieved from a link associated with the image (e.g., if the image includes a link to a webpage associated with the product or service, etc.).

In another example, the one or more machine-learning models may generate a communication (e.g., text, audio segment, etc.) contextually related to the portion of the image. The one or more machine-learning models may generate modifications that animate the portion of the communication to present the communication. In another example, the one or more machine-learning models may communicate with the user using natural language communication (e.g., text, audio, and/or video, etc.) through the media element or generate a new media element to communicate with the user proximate to the media element. The one or more machine-learning models may be configured to discuss the content of the media element, the user interface, the user activity, the context dataset, other media elements, and/or the like. For example, the media element may be an advertisement for the product or service and the one or more machine-learning models may communicate with the user to provide additional information about the product or service, direct the user to a webpage of the product or service, etc. In another example, the one or more machine-learning models may gamify the media element by turning components of the media element into objects that the user can interact with. For example, the one or more machine-learning models may define objects from components on opposing sides of the image to be goalposts and define an object from a component in the center of the image to be a ball. The one or more machine-learning models may animate the image and include instructions to cause the ball object to move when the cursor touches an outer service of the ball object. In another example, the one or more machine-learning models may generate instructions to modify the user interface by, for example, modifying the layout, modifying a color scheme, adding and/or removing media elements, combinations thereof, and/or the like.

The machine-learning node may transmit the instructions output from the one or more machine-learning models to the user interface. The instructions may be in language and/or syntax based on the user interface. For instance, if the user interface is a web-based interface, the instructions may include instructions that can be executed within a web-browser or other web environment (e.g., such as JavaScript, etc.). For other environments, the one or more machine-learning models may output instructions using other language, bytecode, machine code, protocols, syntaxes, etc. The user interface may then execute the instructions to facilitate the modification to the media element or to the user interface. The process may repeat in response to detecting a new event (e.g., new user interaction with the modified media element, etc.). The user interface may use the machine-learning node to continuously generate modifications the media elements of the user interface and/or to the user interface itself each time an event is detected. The modifications may be implemented in near real time (e.g., seconds after the event is detected) making the user interface and the media elements interactive to the user in a manner that is tailored to the user.

In an illustrative example, a computing device may receive interaction data associated with a media element. The interaction data may characterize an instance of interaction between a client device and the media element. The computing device may operate one or more applications or webpages. Alternatively, the computing device may generate, store, and manage media elements that may be presented via one or more applications and/or webpages. The computing device may receive a request for a media element from the one or more applications and/or webpages. The computing device may retrieve a media element from memory (e.g., local memory, remote memory, etc.), retrieve the media element from another device (e.g., such as a content delivery network, database, server, etc.), and/or generate the media element using procedural generation, a machine-learning model, and/or the like. The computing device may then transmit the media element to the one or more applications and/or webpages for presentation. A media element may include alphanumeric text, one or more images, an audio segment, a video segment, combinations thereof, and/or the like. In some examples, the media element may be an advertisement for a product or service.

The interaction data may include an event associated with the interaction data. The event may include an identification of the interaction and a payload (e.g., information associated with the interaction, etc.). For example, the interaction may include, but is not limited to, expiration of a timer, detection of user input, cursor activity (e.g., particular movement, hovering over a location, etc.), detection of sensor input, an interrupt, communications transmitted or received, etc. The information associated with the interaction may include, but is not limited to, information associated with the timer, the input from the user input, the cursor activity, the sensor data that was detected, information associated with the interrupt, the contents of the communications and/or information associated with a source of the communication received from the remote device, combinations thereof, and/or the like.

The computing device may define a training dataset using the interaction data. The training dataset may include one or more features derived from the interaction data. In some instances, the training dataset may be augmented with additional information associated with the client device and/or the user thereof. For example, the training dataset may include features derived from characteristics associated with a user identifier associated with the client device such as, but not limited to, a name or username, demographic information, recent activity associated with the one or more applications or webpages that detected the interaction (e.g., such as activity detected during a current session between the client device and the one or more applications or webpages, activity detected in the preceding hour, etc.), activity associated with the one or more applications or webpages that detected the interaction (e.g., all activity, a selection of particular activity associated media elements of a same time as the media element, activity associated with particular objects of the one or more applications and/or webpages, etc.), device information associated with the client device, network information associated with the client device, combinations thereof, and/or the like.

The computing device may derive a feature vector from the training dataset. The feature vector may be a sequence of features that relate to the event and a client device associated with event. The sequence of features may be ordered according to a particular domain such as a hierarchy, a feature type, time, combinations thereof, and/or the like.

The computing device may execute a machine-learning model using the feature vector derived from the training dataset. The machine-learning model may define a context associated with the instance of user interaction with the media element. The machine-learning model may then generate an interaction response based on the context. The context may be a representation of a state of the one or more applications and/or webpages leading up to the event that characterize the circumstances that form the event. The context may indicate an intent or purpose of a user that triggered the event, an intent or purpose of the interaction, etc. The interaction response output from the machine-learning model may be contextually related to the media segment. For example, the media element may be associated with a product or service and the event may be triggered by input received in association with the media element (e.g., such as a click event, text input, etc.). The interaction response may be based on the media element, the input, and information associated with the client device that modifies the media element into an interactive media element configured to respond to continued input, provide text responses associated with the product or service, etc. For example, an interaction response to text input may be a natural language text response.

The machine-learning model may be configured to generate any response to the interaction that renders the media element interact, which is based on the particular client device and/or user thereof, the media element, the event, the context of the event, combinations thereof, and/or the like. The interaction response may be a response communication, a new media element, a modified media element, an animated version of the media element, a gamified version of the media element (e.g., the media element is modified to become an interactive game, etc.), a modification to the one or more applications, a modification to the one or more webpages, combinations thereof, and/or the like.

In some instances, the machine-learning model may be a generative machine-learning model. Examples of machine-learning models that may be included in ML models 140 include, but are not limited to, neural networks (e.g., such as recurrent neural networks, long short-term memory (LSTM), mask recurrent neural networks, convolutional neural networks, faster convolutional neural networks, etc.), deep learning networks, you only look once (YOLO), EfficientDet, deep learning networks, transformers (generative pre-trained transformers (GPT), Bidirectional Encoder Representations from Transformers (BERTs), text-to-text-transfer-transformer (T5), or the like), generative adversarial networks (GANs), recurrent gated units (GRUs), combinations thereof, or the like. In other instances, the machine-learning model may include one or more machine-learning models configured to process different aspects of the feature vector to generate an interaction response. The one or more machine-learning models may include classifiers, natural language processors, generative machine-learning models (such as any of the aforementioned examples of machine-learning models, etc.), image processing machine-learning models (e.g., convolutional neural networks, etc.), audio processing machine-learning models (e.g., recurrent neural networks, etc.), etc. The one or more machine-learning models may be organized into an ensemble model.

The machine-learning model may be trained using supervised learning, unsupervised learning, semi-supervised learning, transfer learning, metalearning, reinforcement learning, combinations thereof, or the like. The one or more machine-learning models may be trained for a predetermined time interval, predetermined quantity of iterations, and/or until the one or more accuracy metrics are reached (e.g., such as, but not limited to, accuracy, precision, area under the curve, logarithmic loss, F1 score, a longest common subsequence (LCS) such as ROUGE-L, Bilingual evaluation Understudy (BLEU) mean absolute error, mean square error, or the like).

The computing device facilitate a presentation of the interaction response. For example, the computing device may transmit the interaction response to the client device causing the one or more applications and/or webpages to present the interaction response through a user interface. In some instances, the interaction response may include instructions that may be executed by the one or more applications and/or a web browser presenting the one or more webpages. In other instances, the one or more applications and/or a web browser presenting the one or more webpages may include instructions that may execute to present the interaction response.

The computing device may receive new interaction data associated with the interaction response. The new interaction data may include an instance of user interaction with the interaction response. The computing device may continuously receive interaction data corresponding interactions between the client device and media elements of the one or more applications and/or webpages. As the computing device defines responses to the interaction, the computing device may begin receiving interaction data associated with the interaction responses in addition to the interaction data associated with the media elements. The new interaction data may include a new event including an identification of the interaction that triggered the new event and a payload (e.g., information associated with the interaction, etc.).

The computing device may execute the machine-learning model using the training dataset and the new interaction data. The machine-learning model may predict a new context associated with the instance of user interaction with the interaction response. The new context may characterize the circumstances of the instance of interaction with the interaction response such a meaning associated with the payload of the new event, an intent associated with the instance of interaction with the interaction response (e.g., an intent associated with what triggered the new event, an intent associated with the payload of the new event, etc.), the payload of the new event, combinations thereof, one or more inferences associated with user input received by the one or more applications and/or webpages before the new event was detected, predicted user input after detecting the event, combinations thereof, and/or the like.

The computing device may update the training dataset using the new context. The updated training dataset may be used by the machine-learning model to generate a new interaction response to maintain the interactivity of the media element. For example, the interaction response may be a communication associated with the product or service represented by the media element and the new interaction data may include a response communication by the client device and/or user thereof. The computing device may generate a new interaction response including an additional communication responding to the communication response to continue the conversation. The updated training dataset may enable the computing device to generate improved interaction responses with respect to the particular client device (and/or the user thereof). The updated training dataset may also be used for training dataset to execute training iterations on the machine-learning model, train new machine-learning models, augment training datasets associated with other client devices and/or the users thereof (e.g., such as when the training datasets associated with the other client devices are include insufficient data, etc.).

If the computing device receives more interaction data from the client device, the computing device may determine if the interaction data is associated with a same session as the previously received interaction data. A session may correspond to a time interval over which the client device and/or the user thereof operates the one or more applications and/or webpages. For example, a session may correspond to a time interval in which a user operates an application. The session may terminate when the user ceases to operate the application. The computing device may monitor activity with the one or more applications and/or webpages through the interaction data. If the interaction data is received within a threshold time interval beginning when the last interaction data was received, then the computing device may determine the interaction data to be part of the same session and the process may execute the machine-learning model using the updated training dataset and the interaction data as part of the session. If the interaction data is received after expiration of the threshold time interval, then the computing device may revise the updated training dataset to exclude the previous interaction data and execute the machine-learning model using the updated training dataset without the previous interaction data.

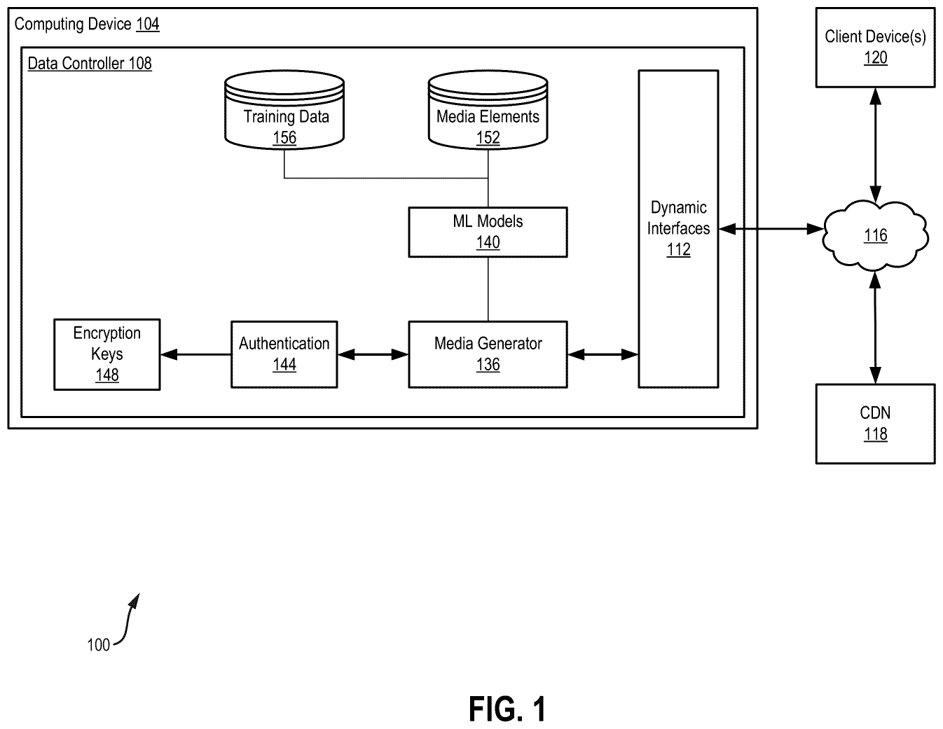

FIG. 1 illustrates a block diagram of an example media generation system that augments machine-learning models to generate interactive media according to aspects of the present disclosure. The machine-learning models described herein include generative models (e.g., models configured to generate text, images, audio, and/or video). The machine-learning models, the training datasets, and/or the input data provided to the machine-learning models may be continuously manipulated to enable generating interactive media for presentation through remote interfaces. In some instances, the interactive media may be generated in near real time as a user is operating a remote interface.

The media generation system may include data controller system 100, which may manage machine-learning models configured to generate media elements for presentation by one or more client devices. Data controller system 100 may include one or more training datasets for training the machine-learning models and for defining user-customized data structures. Each media element may include a representation of one or more text, images, video segments, audio segments, combinations thereof, and/or the like.

Computing device 104 may be a hardware processing node of data controller system 100. In some instances, computing device 104 may be one of multiple hardware processing nodes allowing for distributed media generation, management of distributed datasets, load balancing, etc. Computing device 104 may include processing hardware including processors, volatile and non-volatile memories, graphics processing units (GPUs), etc. Computing device 104 may include data controller 108, which may manage requests for media elements and generate responses to indications of interaction with media elements. In some instances, data controller 108 may be a hardware component that operates within computing device 104 such as, for example, a field programmable gate array, application specific integrated circuit, microcontroller, combinations thereof, or the like. In other instances, data controller 108 may be a software component executed by the processing hardware of computing device 104. In still yet other instances, data controller may be a hardware component and a software component in which some operations of data controller 108 may be facilitated by the hardware component and some operations of data controller 108 may be facilitated by the software component. In those instances, the software component may be executed by the hardware component, by the processing hardware of computing device 104, by the processing hardware of another computing device, combinations thereof, or the like.

Data controller 108 may include dynamic interfaces 112, which may operate interfaces enabling communication with disparate devices and interfaces presenting controls of data controller 108 to users of computing device 104 (e.g., users directly connected to computing device 104, users of client device 120 and/or other client devices, users of media data sources (e.g., 124-132). Dynamic interfaces 112 may include one or more predefined interfaces and instructions for generating dynamic interfaces in response to communications received via network 116 (e.g., cloud network, local area network or wide area network, the Internet, etc.). For example, dynamic interfaces 112 may define custom interfaces for particular device types (e.g., such as mobile devices, desktop devices, accessibility devices, etc.), operating systems, software platforms, etc. to enable uniform presentation and interaction with data controller 108.

Data controller 108 may receive requests from remote devices through dynamic interfaces 112 to access datasets and/or pre-generated media, generate media, modify media, combinations thereof, and/or the like. For example, a media element may be presented via webpage or application accessible to client device 120. The webpage or application may execute a request to computing device 104 upon detecting an event associated with a media element. The request may be a request for a new media element to replace the associated media element, request to modify the associated media element, request for instructions to modify the associated media element, combinations thereof, and/or the like. The request may include an identification of an operation to perform, an identification an associated media element, contextual details associated with the operation (e.g., an identification of an interface that transmitted the request, user information, an identification of a media type associated with operation, an identification the event that triggered the request, an identification of previous requests during a same session or involving the same user, etc.), authentication data (e.g., a token, access credentials such as a username and password, encryption keys, etc.), combinations thereof, or the like. Dynamic interfaces 112 may parse the request and pass the parsed request to media generator 136.

Media generator 136 may determine if the request requires access privileges (e.g., executing the operations requires access to training datasets and/or media elements designated as protected data, etc.). The access privileges may be defined for each training dataset and/or media element. Access privileges may indicate whether particular credentials are needed to access the training dataset and/or media element and/or whether access is limited to particular devices or device types. If media generator 136 determines that the request requires access privileges, then the request may be passed to authentication 144 for processing. Authentication 144 may use the authentication data to authorize or deny the request. If the request did not include the authentication data, authentication 144 may request the authentication data from the device that generated the request.

Authentication 144 may process the authentication data based on the operation requested and the protected data to be accessed to execute the operation. Once authenticated, authentication 144 may identify a storage location of the protected data and return a pointer to media generator 136 enabling media generator 136 to access the protected data. Alternatively, authentication 144 may transmit an approval to media generator 136 enabling media generator 136 to access the protected data. If the protected data is encrypted, authentication 144 may use encryption keys 148 to identify one or more encryption key associated with the protected data using the authentication data. In some instances, the encryption key and the authentication data are combined (e.g., via a bitwise operation, appending the encryption key to the authentication data, via hashing, etc.) to generate a key configured to decrypt the protected data. If the operation is a read or write operation, then media generator 136 may retrieve the requested training datasets from training datasets 156 and/or media elements from media elements 152.

Media elements 152 may store media elements (e.g., text, images, audio segments, video segments, interactive media, combinations thereof, and/or the like) that can be transmitted to client device 120 and/or usable by ML models 140 to generate new media elements. Media generator 136 may store media elements generated by ML models 140 in media elements 152. In some instances, media generator 136 may store media elements received from one or more remote device (e.g., such as client devices 120, cloud networks, content delivery networks (CDN) 118, servers, databases, webhosts, combinations thereof, and/or the like) in media elements 152 for subsequent distribution or processing by ML models 140.

Training datasets 156 may store training datasets usable by media generator 136 to train ML models 140 and bias the operations of ML models 140 to customize an output to a particular user or group of users. Training datasets 156 may include media elements and/or links to media elements, metadata associated with media elements, user information associated with particular users or user groups, device information (e.g., associated with client devices 120, the device that will present the generated media elements, etc.), media element specifications (e.g., predefined instructions and/or characteristics of interactive media elements usable to define interactions for media elements such as, but not limited to, instruction sets provide interactivity in media elements, descriptions of interactivity, descriptions of interactive media elements, an identification of types of interactive media elements, combinations thereof, and/or the like), labels, combinations thereof, and/or the like. The training datasets may be generated by media generator 136, by ML models 140 (e.g., through operation of ML models 140, feedback, etc.), user input, combinations thereof, and/or the like.

Media generator 136 may manage the training, initiation, and execution of machine-learning (ML) models 140. ML models 140 may include one or more machine-learning models configured to generate media elements, generate interactive media elements, modify media elements, modify interactive media elements, combinations thereof, and/or the like. ML models 140 may include generative machine-learning models, classifiers, natural language processors, combinations thereof (e.g., ensemble models), and/or the like. Examples of machine-learning models include, but are not limited to, neural networks (e.g., such as recurrent neural networks, long short-term memory (LSTM), mask recurrent neural networks, convolutional neural networks, faster convolutional neural networks, etc.), deep learning networks, you only look once (YOLO), EfficientDet, deep learning networks, transformers (generative pre-trained transformers (GPT), Bidirectional Encoder Representations from Transformers (BERTs), text-to-text-transfer-transformer (T5), or the like), generative adversarial networks (GANs), recurrent gated units (GRUs), combinations thereof, or the like.

Media generator 136 may train one or more machine-learning models of ML models 140 using a training dataset identified by training datasets 156 based on the media elements that are to be generated by each machine-learning model. Alternatively, media generator 136 may use one or more training datasets to train a general machine-learning model configured to generate multiple different types of media elements. The machine-learning model may be trained using supervised learning, unsupervised learning, semi-supervised learning, transfer learning, reinforcement learning, combinations thereof, or the like. The one or more machine-learning models may be trained for a predetermined time interval, predetermined quantity of iterations, and/or until one or more accuracy metrics are reached (e.g., such as, but not limited to, accuracy, precision, area under the curve, logarithmic loss, F1 score, mean absolute error, mean square error, or the like).

Media generator 136 may determine if the request can be satisfied by an existing machine-learning model of ML models 140. For example, media generator 136 may determine if a trained model exists that is configured to execute the operation of the request, generate a media element according to the request, tailor generation of a media element to particular user or user groups, etc. If ML models 140 does not include a trained machine-learning model that can satisfy the request, media generator 136 may instantiate a new machine-learning model and execute a training process as previously described. Alternatively, media generator 136 may access an external machine-learning model configured to satisfy the request such as a machine-learning model hosted by one or more remote devices or cloud networks. If ML models 140 does includes a trained machine-learning model that can satisfy the request, then media generator 136 may generate a feature vector from the request that may be usable as input to the trained machine-learning model of ML models 140.

Media generator 136 may derive a feature vector from the request. The feature vector may include an identification of an operation (e.g., generate a new media element, modify a media element, load a media element, etc.), information associated with a media element that is to be generated or modified, contextual details associated with the operation, combinations thereof, and/or the like.

In some instances, ML models 140 may be configured to generate media elements that are tailored to particular users or user groups (e.g., a set of users sharing one or more characteristics). In some examples, ML models 140 may train a machine-learning model using training datasets associated with the particular user or user groups. Such a trained machine-learning model may generate media elements with a high degree of tailoring to the particular user or user groups (e.g., based on accuracy metrics, user feedback, etc.). Generating individual machine-learning models for particular users and/or user groups may require a large quantity of data associated with the particular users and/or user groups, which may not be available. In addition, generating individual machine-learning models may take time to train and use significant storage resources of computing device 104. In examples where computing device 104 lacks the processing resources or data to train and store individual machine-learning models for particular users and/or user groups, data controller 108 may modify the input feature vectors and/or the first layer of the machine-learning model to enable the machine-learning model to tailor the output of the machine-learning model in a same manner as if the machine-learning model is trained using datasets associated with particular users and/or user groups. Modifying input feature vectors or the first layer of the machine-learning model may enable quick deployment of new machine-learning models, reduce the data needed to train machine-learning models to a target accuracy, etc. while still providing the same degree of tailored output.

For example, media generator 136 may generate custom training datasets associated with particular users, user groups, media element types, combinations thereof, and/or the like. The custom training datasets may be used to bias a particular iteration of the machine-learning model causing the machine-learning model to generate an outcome tailored toward the particular users, user groups, media element types, combinations thereof, and/or the like of the custom training dataset. Media generator 136 may generate a feature vector for input to ML models 140 to execute the operation of the request. Media generator 136 may then modify the feature vector using a custom training dataset to cause ML models 140 to generate a tailored output for a particular user or user group. The feature vector may be modified by inserting features from the custom training dataset into particular locations of the feature vector. In some instances, the particular locations may be selected based on features proximate to the particular locations. For example, features from the custom training dataset may be inserted proximate to features of a same or similar type, data type, value, context, hierarchy, sequencing, combinations thereof, and/or the like. Alternatively, media generator 136 may insert the features of the custom training dataset into predetermined locations of the feature vector such as, but not limited to, the beginning, at the end, in the middle, in one or more predetermined locations, etc.

Media generator 136 may select one or more machine-learning models of ML models 140 to execute the operation. Media generator 136 may then pass the feature vector (or modified feature vector) to ML models 140 along with an identification of the selected one or more machine-learning models. If an external model is selected to satisfy the request them media generator 136 may transmit the feature vector (or modified feature vector) to the external model. Media generator 136 may execute the machine-learning model immediately or schedule the execution of the one or more machine-learning models (e.g., for load balancing, etc.). The one or more machine-learning models may be executed individually or in groups (e.g., in series, in parallel, and/or partially in series and partially in parallel, etc.).

Media generator 136 may receive the output from the one or more machine-learning models. The output may be a media element, a modified media element, a modification to a media element, and/or the like. For example, a webpage hosting a media element may request instructions to modify the media element to become an interactive media element. The output may be transmitted to the device that generated the request. The output may also be processed by media generator 136 for future use. For example, a subsequent request may be received from the same device and associated with the output. The subsequent request may include a request for a modification to the media element of the output. By maintaining information associated with each output generated by the one or more machine-learning models, media generator 136 can provide a pseudo memory enabling future operations of the one or more machine-learning models to execute with “knowledge” of previous executions and respective outputs. Media generator 316 may provide a long-term pseudo memory (e.g., in which information from a large quantity of past executions are stored) or a short-term memory (e.g., in which information from small quantity of the most recent executions are stored). The quantity of executions that retained may be adjusted based on operation of the one or more machine-learning models, media generator 136, user input, and/or the like. In some examples, short-term memory may include every execution of the machine-learning model during a particular session of the requesting device (e.g., a duration of time a user accesses a webpage, application, etc.). In some examples, short-term memory may include a predetermined quantity of the most recent executions of the one or more machine-learning models. Once the predetermined quantity is reached, media generator 136 may purge information associated with the oldest execution of the one or more machine-learning models each time the one or more machine-learning models execute.

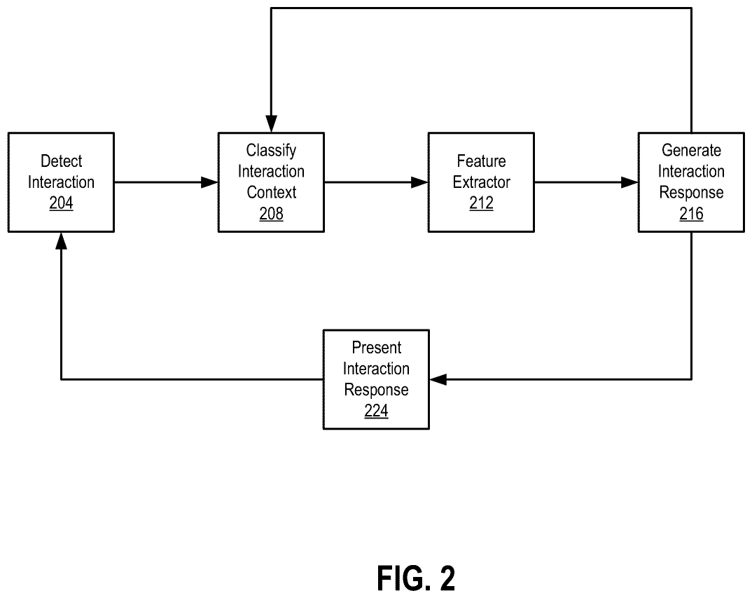

FIG. 2 illustrates a block diagram of an example process of generating interactive media for according to aspects of the present disclosure. An interface (e.g., a webpage, application, graphical user interface, and/or the like executing on (or accessible by) a computing device operated by a user) may present one or more media elements (e.g., image, text, audio segment, video segment, interactive media such as a game or the like, combinations thereof, and/or the like). At block 204 the interface may generate an event indicative of interaction with the media element. The event may be generated by the interface based on user input (e.g., such as alphanumeric strings, images, cursor movement, cursor click events, etc.), sensor measurements, lack of user input (e.g., over a predetermined time interval, one or more timers (e.g., such as a current Epoch timestamp or other formatted timestamp representing a current time, time between user input, time since user input was last received, time since the interface was loaded by the computing device, etc.), combinations thereof, and/or the like. For example, a user may move a cursor over the media element causing the interface to generate an event. If cursor click input is detect then the interface may generate another event.

At block 208, a context of the interaction may be classified. In some instances, the interface may transmit the event along with information associated with the event (e.g., information associated with the user, information associated with the computing device, information associated media element and/or the interface, user input received prior to the event, user input that triggered generation of the event, previous events generated during a same session of the interface, combinations thereof, and/or the like) to a remote device. The remote device may use the event, the information associated with the event, and/or information already known about the user to define a context associated with the interaction. In other instances, the interface may define the context associated with the interaction. The context of the interaction may indicate the circumstances that triggered generation of the event and/or inferences derived from the circumstances that triggered generation of the event such as a predicted intent of the user, etc. In some examples, the context of the interaction may be generated by a machine-learning model using any of the event, the information associated with the event, the information already known about the user, combinations thereof, and/or the like.

At block 212, a feature extractor may extract features from the event, the information associated with the event, and/or information already known about the user. The features may be organized into a feature vector that may be passed as input into the machine-learning model. The machine-learning model may be a generative machine-learning model configured to process the event and context of the interaction to define an interaction response. In some instances, the interaction response may be a communication (e.g., such as alphanumeric text, audio segments, etc.). In other instances, the interaction response may be a modification to the media element that can convert the media element into an interactive media element.

At block 216, the machine-learning model may process the feature vector to generate the interaction response. The interaction response may be a communication (e.g., such as a communication responding to the event based on the context), a modification to the media element that can convert the media element into an interactive media element, combinations thereof, and/or the like. If the interaction response is a communication, then communication of the interaction response may be presented by the interface in association with the associated media element (e.g., over the media element, proximate to the media element, in a location associated with the media element, labeled with the media element, etc.). Inf the interaction response is a modification to the media element, then the interaction response may include a modified version of the media element (e.g., to be presented in place of the current media element, proximate to the current media element, etc.), instructions (e.g., such as a JavaScript, bytecode, machine code, and/or other machine executable or interpretable instructions) that when implemented by the interface cause a modification to the media element.

For example, when the cursor clicks on the media element, the machine-learning model may generate a modification to the media element causing the media element to present an audio segment providing information on an object or service depicted by the media element. In other examples, the modification may be more complex such as instructions that define a game (e.g., including animations that can be applied to objects depicted by the media element, audio segments, rules, etc.) allowing for a single modification allow for continuous, unique interactions with the user.

Examples of machine-learning models include, but are not limited to, neural networks (e.g., such as recurrent neural networks, long short-term memory (LSTM), mask recurrent neural networks, convolutional neural networks, faster convolutional neural networks, etc.), deep learning networks, you only look once (YOLO), EfficientDet, deep learning networks, transformers (generative pre-trained transformers (GPT), Bidirectional Encoder Representations from Transformers (BERTs), text-to-text-transfer-transformer (T5), or the like), generative adversarial networks (GANs), recurrent gated units (GRUs), combinations thereof, or the like. In other instances, the machine-learning model may include one or more machine-learning models configured to process different aspects of the feature vector. The machine-learning model may include classifiers, natural language processors, generative machine-learning models (such as any of the aforementioned examples of machine-learning models, etc.), image processors (e.g., convolutional neural networks, etc.), audio processors (e.g., recurrent neural networks, frequency filters and/or amplifiers, etc.), etc.

The machine-learning model may be trained using supervised learning, unsupervised learning, semi-supervised learning, transfer learning, metalearning, reinforcement learning, combinations thereof, or the like. The machine-learning model may be trained for a predetermined time interval, predetermined quantity of iterations, and/or until the one or more accuracy metrics are reached (e.g., such as, but not limited to, accuracy, precision, area under the curve, logarithmic loss, F1 score, a longest common subsequence (LCS) such as ROUGE-L, Bilingual evaluation Understudy (BLEU) mean absolute error, mean square error, or the like).

At block 224, the output from the machine-learning model may be presented. If the machine-learning model is located remote from the interface, the output may be converted into a set of instructions. The set of instructions may be transmitted to the computing device (and/or the device hosting the interface). The set of instructions may be executed by the interface causing the interface to present the interaction response.

The output of the machine-learning model may also be passed to block 208, where the output of the machine-learning model may be used with along with subsequent events to reinforce the machine-learning model. For example, a subsequent event may be generated by the interface in response to the interaction response presented at block 224. The subsequent event may be used as feedback for the machine-learning model to improve context classification at block 208, feature extraction at block 212, and improve the generation of interaction responses (e.g., generate interaction responses that may be more tailored to particular users and/or user groups, improved instruction sets for modifying media elements, etc.).

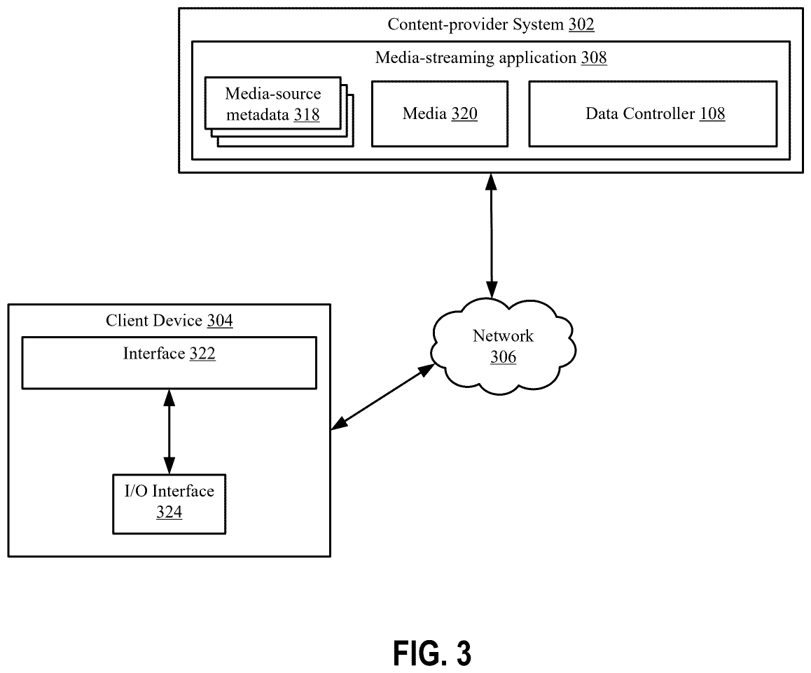

FIG. 3 illustrates a block diagram of an example media generation system configured to generate interactive media using augment machine-learning models according to aspects of the present disclosure. Content-provider system 302 includes an implementation of data controller 108 (as described in connection to FIG. 1) that operates within a remote environment (e.g., content-provider system 302). Client device 304 may be a computer (e.g., desktop, laptop computer), mobile device (e.g., smartphone, tablet, e-reader, etc.), display device (e.g., television, monitor, etc.), or the like. Client device 304 may include processing hardware (e.g., central processing unit, graphical processing unit, volatile and/or non-volatile memories, input/output interfaces, network interfaces, etc.) to enable presentation of graphical media (e.g., via interface 322 or another application). Interface 322 may include interfaces configured to present information such as, but not limited to, graphical user interfaces of webpages and/or applications, command lines, programmable interfaces, combinations thereof, and/or the like. The information presented by interface 322 may include one or more media elements.

Client device 304 may receive input from one or more input/output devices through I/O interface 324 usable to control operation of client device 304 and interface 322. Example input/output devices include, but are not limited to, a keyboard and/or mouse, camera (e.g., for eye tracking, gestures, etc.), touch interface (e.g., capacitive touchscreen, or the like for touch-based gestures, etc.), motion sensors (e.g., accelerometers, gyroscopes, etc. configured to measure motion in one or more axes), a microphone (e.g., for speech recognition and voice commands, etc.), a display, and/or the like. Different client devices may include different input/output devices. The particular input/output devices included in a client device may depend on the client device type. For instance, a mobile device, such as a smartphone, may include a camera, touch interface, motion sensors, etc. but exclude a keyboard or mouse. A desktop computer may include a keyboard and mouse but exclude a touch interface and motion sensors.

Content-provider system 302 may store media 320 (e.g., media elements, instructions for defining media elements, etc.), media-source metadata 318 associated with media 320, and an instance of data controller 108. Media 320 may include media elements generated by data controller 108 or media elements received by content-provider system 302 for distribution to client device 304 and/or other client devices (not shown). Client device 304 may transmit a request for graphical media through network 306 and in response, content-provider system 302 may transmit the requested graphical media to client device 304 (or cause the graphical media to be transmitted to client device 304 if not stored locally by content-provider system 302). Media-source metadata 318 may store metadata associated with media 320. The metadata may include information associated with the creation of the media elements (e.g., author, publishing date, location, etc.), events associated with the generation of the media elements, user information associated with the generated media elements, technical information (e.g., such as file types, file sizes, image resolution, aspect ratios, color information, etc.), features that may be usable by machine-learning models of data controller 108, and/or the like. In some instances, the metadata may be transmitted with graphical media requested by client device 304 to improve processing of the graphical media and to provide additional information associated with the graphical media.

In some instances, data controller 108 may be implemented as a software component that may be executed by media-streaming application 308. In other instances, data controller 108 may be implemented as a hardware component such as an application-specific integrated circuit, field programmable gate array, mask programmable gate array, or as set of interconnected components (e.g., such as central processors, graphical processing units, memory, microcontrollers, etc.), that execute operations described herein. For instance, the hardware component may include a thread scheduler that schedules instructions for processing by content-provider system 302 and/or the hardware components to improve the processing speeds and/or consumption of processing resources. The hardware component may offload machine-learning processes to a graphics processing unit (GPU) of content-provider system 302, which may more efficiently execute the processes and execute other processes internally. If a processing bottleneck occurs, the hardware component may adaptively route execution of processes to the central processing unit of content-provider system 302 until the processing bottleneck is alleviated. The hardware component may operate as a specialized processing device that may operate within another processing device and selectively use the processing resources of the another processing device for improved operation of the hardware component.

Data controller 108 may be configured to generate media elements, modify media elements (e.g., generate modified versions of media elements and/or generate instructions that when execute facilitate the modification of media elements, etc.), generate interactive media elements, define a context associated with events, combinations thereof, and/or the like. Data controller 108 may include one or more machine-learning models configured to generate various media types associated with a media. Examples of media types that may be generated by data controller 108 include, but are not limited to, text, images, video segments (e.g., such as, but not limited to, media in a graphics interchange format, animated portable network graphics, Moving Picture Experts Group, audio video interleave, combinations thereof, and/or the like), interactive media (e.g., video games, web-based media, etc.), webpages and/or documents therefor (e.g., such as, but not limited to, blog posts, encyclopedia entries, entries for an online publication, entries for crowdsourced and/or community-edited publications, instructions such as hypertext markup language or JavaScript, etc.), collateral (e.g., marketing collateral such as promotional media for the mixed-media dataset, media associated with or included in the mixed-media dataset, and/or the like), audio segments, combinations thereof, or the like.

Data controller 108 may be configured to generate media elements in response to detecting an interaction with a first media element presented by interface 322. The first media element may be a static element (e.g., does not include instructions to respond to input). The generated media element may be contextually related to the first media element and the interaction. For example, selecting the first media element may cause data controller 108 to generate a modified version of the first media element with additional text, audio segments, animation, combinations thereof, and/or the like. The modified version of the first media element may replace the first media element to give an appearance of interactivity within interface 322. In another example, clicking and dragging a portion of the first media element may cause data controller 108 to generate a modified version of the first media element that includes a visual distortion where the click occurred over the first media element and in the direction in which the first media element was dragged. Alternatively, or additionally, data controller 108 may generate instructions that may be executed by interface 322 and/or client device 304. The instructions may facilitate a modification to the media element, generate one or more effects (e.g., such as, but not limited to, animation the media element or a portion thereof such as an object depicted by the media element, modify color, modify contrast, highlight text and/or a portion of the media element, execute one or more image processing operations (e.g., filtering, affine transformations, image denoising, etc.), combinations thereof, and/or the like), generate audio segments, generate natural language communications, interpret natural language communications, combinations thereof, and/or the like.

For example, client device 304 may generate interface 322 to present an interface of content-provider system 302 that includes a media element. A user may interact with interface 322 using an I/O device such as mouse or keyboard. Interface 322 may generate an event upon detect input from the I/O device proximate to the media element (e.g., such as a cursor hover over event, a mouse click, alphanumeric input, etc.). The event may be processed by data controller 108 of content-provider system 302, which may generate an interaction response using the machine-learning model. The interaction response may include a modified version of the media element. Media-streaming application 308 may transmit the modified version of the media element to client device 304, which may cause interface 322 to replace the media element with the modified version of the media element making the media element appear to be interactive to the user. The process may continue in real time while the user is operating interface 322 such that subsequent events caused by the I/O device may generate additional modifications to the media element (e.g., a new version of the immediately previous version of the media element) that may replace immediately previous version of the media element.

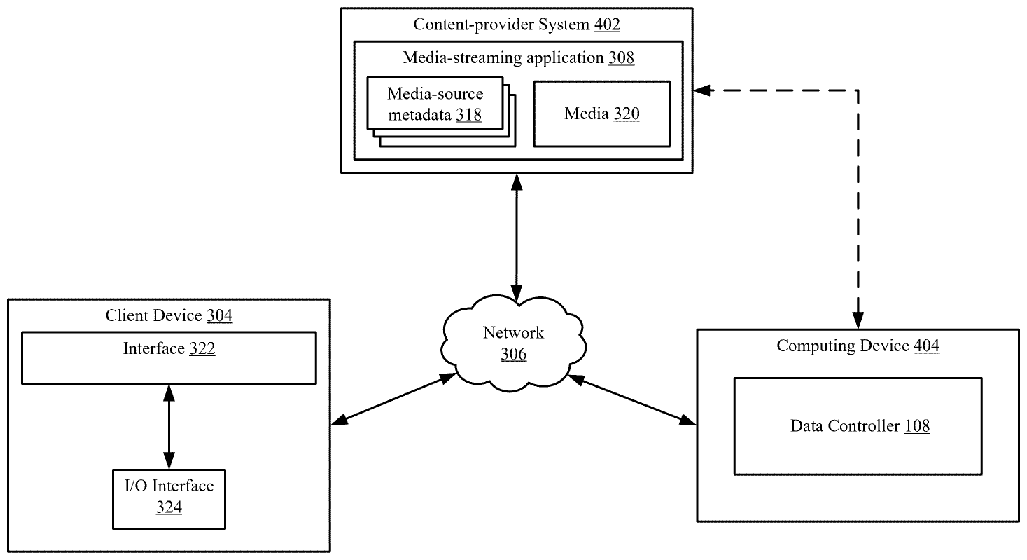

FIG. 4 illustrates a block diagram of an example distributed media generation system configured to generate interactive media using augmented machine-learning models according to aspects of the present disclosure. Content-provider system 402 may provide remote devices (e.g., such as client device 304) access to media 320 (e.g., media elements, etc.) and media generation services (e.g., via media-source metadata 318, computing device 404, and/or the like). Content-provider system 402 may be configured to perform the operations of content-provider system 302 of FIG. 3 with data controller 108 being partially or entirely operated by a remote device (e.g., computing device 404).

Computing device 404 may be a dedicated processing device designed to execute particular types of processes. For example, data controller 108 may include one or more machine-learning models for generating various types of media elements. Computing device 404 may include one or more graphics processing units (GPUs) to improve executing efficiency of machine-learning processes. By separating the machine-learning tasks of data controller 108 from other processing tasks of content-provider system 402, content-provider system 402 may improve the rate in which read/write operations are executed (e.g., by data controller 108) without reducing efficiency of processes of content-provider system 402 (e.g., such as transmitting media to client devices such as client device 304, etc.).

Content-provider system 402 may receive a media generation request (e.g., such as a request to generate a new media element, modify an existing media element, generate interactive media elements, interaction responses, etc.) and transmit the request to computing device 404 (e.g., directly, through network 306, etc.). Data controller 108 of computing device 404 may generate an output based on the request (e.g., such as a new media element, a modification of an existing media element such as a modified version of the media element or instructions therefore, an interactive media element, interaction response, etc.). In some instances, the output may be transmitted to content-provider system 402. Content-provider system 402 may store the output in media 320 (e.g., for future distribution to client devices, etc.) and metadata associated with the output in media-source metadata 318. If content-provider system 402 is configured to transmit the output to client device 304, then content-provider system 402 may transmit the output to client device 304. Alternatively, or additionally, computing device 404 may be configured to transmit the output directly to client device 304. In other instances, computing device 404 may be configured to transmit the output directly to client device 304 without sending the output to content-provider system 402.

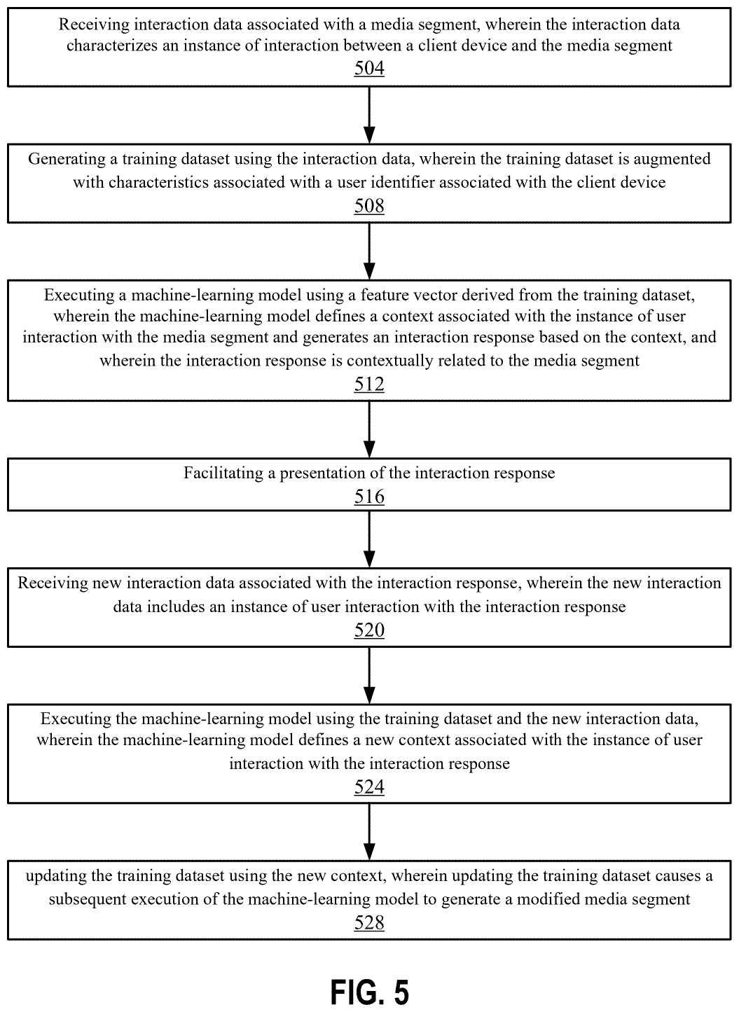

FIG. 5 illustrates a flowchart of an example process for augmenting machine-learning models for interactive media according to aspects of the present disclosure. At block 504, a computing device may receive interaction data associated with a media element. The interaction data may characterize an instance of interaction between a client device and the media element. In some instances, the computing device may operate an application or webpage accessible to the client device. In other instances, the application or webpage may be hosted by another remote device and include instructions that when executed by the client device, cause the client device to connect to and/or transmit communications to the computing device. The application or webpage may include a user interface configured to present one or more media elements.

The computing device may receive a request for a media element from the application and/or webpage. The computing device may retrieve a media element from memory (e.g., local memory, remote memory, etc.), retrieve the media element from another device (e.g., such as a content delivery network, database, server, etc.), and/or generate the media element using procedural generation, a machine-learning model, and/or the like. The computing device may then transmit the media element to the application and/or webpage for presentation. A media element may include alphanumeric text, one or more images, an audio segment, a video segment, combinations thereof, and/or the like. In some examples, the media element may be an advertisement for a product or service.

The interaction data may include an event corresponding to the instance of interaction between the client device and the media element. The event may include an identification of the interaction that triggered the event and a payload (e.g., information associated with the interaction, etc.). The interaction may include, but is not limited to, expiration of a timer, detection of user input, cursor activity (e.g., particular cursor movement, hovering over a location, a mouse click, etc.), detection of sensor input, an interrupt, communications transmitted or received, etc. The information associated with the interaction may include, but is not limited to, information associated with the timer, the input from the user input, the cursor activity, the sensor data that was detected, information associated with the interrupt, the contents of the communications and/or information associated with a source of the communication received from the remote device, combinations thereof, and/or the like. For example, an event may include an indication that user input is detected and the payload may include the user input.

At block 508, the computing device may define a training dataset using the interaction data. The training dataset may include one or more features derived from the interaction data. In some instances, the training dataset may be augmented with additional information associated with the client device and/or the user thereof. For example, the training dataset may include features derived from characteristics associated with a user identifier associated with the client device such as, but not limited to, a name or username, demographic information, recent activity associated with the one or more applications or webpages that detected the interaction (e.g., such as activity detected during a current session between the client device and the one or more applications or webpages, activity detected in the preceding hour, etc.), activity associated with the one or more applications or webpages that detected the interaction (e.g., all activity, a selection of particular activity associated media elements of a same time as the media element, activity associated with particular objects of the one or more applications and/or webpages, etc.), device information associated with the client device, network information associated with the client device, combinations thereof, and/or the like.

The computing device may derive a feature vector from the training dataset. The feature vector may be a sequence of features that relate to the event and a client device associated with event. The sequence of features may be ordered according to a particular domain such as a hierarchy, a feature type, time, combinations thereof, and/or the like. In some examples, the computing device may derive the feature vector form the training dataset by selecting features from the training dataset and/or generating new features from the features of the training dataset (e.g., via interpolation, extrapolation, inferences, predictions, combinations thereof, and/or the like.

At block 512, the computing device may execute a machine-learning model using the feature vector derived from the training dataset. The machine-learning model may define a context associated with the instance of user interaction with the media element. The machine-learning model may then generate an interaction response based on the context. The context may be a representation of a state of the application and/or webpage leading up to the event that characterize the circumstances that form the event. The context may indicate an intent or purpose of a user that triggered the event, an intent or purpose of the interaction, a predicted meaning of the interaction or payload, etc. The interaction response output from the machine-learning model may be contextually related to the media segment. For example, the media element may be associated with a product or service and the event may be triggered by input received in association with the media element (e.g., such as a click event, text input, etc.). The context may indicate the user's intent interacting with the media element and generate an interaction response that address the user's intent. The interaction response may be based on the media element, the input, and information associated with the client device that modifies the media element into an interactive media element configured to respond to continued input, provide text responses associated with the product or service, etc. For example, an interaction response to text input may be a natural language text response.

The machine-learning model may be configured to generate any response to the interaction that renders the media element interact, which is based on the particular client device and/or user thereof, the media element, the event, the context of the event, combinations thereof, and/or the like. The interaction response may be a response communication, a new media element, a modified media element, an animated version of the media element, a gamified version of the media element (e.g., the media element is modified to become an interactive game, etc.), a modification to the one or more applications, a modification to the one or more webpages, combinations thereof, and/or the like.

In some instances, the one or more machine-learning models may be a generative machine-learning models. Examples of machine-learning models include, but are not limited to, neural networks (e.g., such as recurrent neural networks, long short-term memory (LSTM), mask recurrent neural networks, convolutional neural networks, faster convolutional neural networks, etc.), deep learning networks, you only look once (YOLO), EfficientDet, deep learning networks, transformers (generative pre-trained transformers (GPT), Bidirectional Encoder Representations from Transformers (BERTs), text-to-text-transfer-transformer (T5), or the like), generative adversarial networks (GANs), recurrent gated units (GRUs), combinations thereof, or the like. In other instances, the machine-learning model may include one or more machine-learning models configured to process different aspects of the feature vector to generate an interaction response. The one or more machine-learning models may include classifiers, natural language processors, generative machine-learning models (such as any of the aforementioned examples of machine-learning models, etc.), image processing machine-learning models (e.g., convolutional neural networks, etc.), audio processing machine-learning models (e.g., recurrent neural networks, etc.), etc. The one or more machine-learning models may be organized into an ensemble model.

The machine-learning model may be trained using supervised learning, unsupervised learning, semi-supervised learning, transfer learning, metalearning, reinforcement learning, combinations thereof, or the like. The one or more machine-learning models may be trained for a predetermined time interval, predetermined quantity of iterations, and/or until the one or more accuracy metrics are reached (e.g., such as, but not limited to, accuracy, precision, area under the curve, logarithmic loss, F1 score, a longest common subsequence (LCS) such as ROUGE-L, Bilingual evaluation Understudy (BLEU) mean absolute error, mean square error, or the like).

At block 516, the computing device may facilitate a presentation of the interaction response. For example, the computing device may transmit the interaction response to the client device causing the one or more applications and/or webpages to present the interaction response through a user interface. In some instances, the interaction response may include instructions that may be executed by the one or more applications and/or a web browser presenting the one or more webpages. In other instances, the one or more applications and/or a web browser presenting the one or more webpages may include instructions that may execute to present the interaction response.

At block 520, the computing device may receive new interaction data associated with the interaction response. The new interaction data may include an instance of user interaction with the interaction response. The computing device may continuously receive interaction data corresponding interactions between the client device and media elements of the one or more applications and/or webpages. As the computing device defines responses to the interaction, the computing device may begin receiving interaction data associated with the interaction responses in addition to the interaction data associated with the media elements. The new interaction data may include a new event including an identification of the interaction that triggered the new event and a payload (e.g., information associated with the interaction, etc.).

At block 524, the computing device may execute the machine-learning model using the training dataset and the new interaction data. The machine-learning model may predict a new context associated with the instance of user interaction with the interaction response. The new context may characterize the circumstances of the instance of interaction with the interaction response such a meaning associated with the payload of the new event, an intent associated with the instance of interaction with the interaction response (e.g., an intent associated with what triggered the new event, an intent associated with the payload of the new event, etc.), the payload of the new event, combinations thereof, one or more inferences associated with user input received by the one or more applications and/or webpages before the new event was detected, predicted user input after detecting the event, combinations thereof, and/or the like.

At block 528, the computing device may update the training dataset using the new context. Updating the training dataset may include storing the interaction data, the interaction response, and the new interaction data into the training dataset. Updating the training dataset may also including storing features learned about the client device and/or the user thereof from the interaction data, the interaction response and/or the context, the new interaction data, and/or the like such as, but not limited to, preferences, user interests, user intents, demographic information associated with the user, an indication as to what the user thinks about a product or service represented by a media element, combinations thereof, and/or the like. In some examples, the updating of the training dataset using the new context (in block 528) the machine-learning model, for instance to improve the accuracy of the machine-learning model in context prediction (e.g., for further new contexts).

The updated training dataset may be used by the machine-learning model to generate a new interaction response to maintain the interactivity of the media element. For example, the interaction response may be a communication associated with the product or service represented by the media element and the new interaction data may include a response communication by the client device and/or user thereof. The computing device may generate a new interaction response including an additional communication responding to the communication response to continue the conversation. The updated training dataset may enable the computing device to generate improved interaction responses with respect to the particular client device (and/or the user thereof). The updated training dataset may also be used for training dataset to execute training iterations on the machine-learning model, train new machine-learning models, augment training datasets associated with other client devices and/or the users thereof (e.g., such as when the training datasets associated with the other client devices are include insufficient data, etc.).

If the computing device receives more interaction data from the client device, the computing device may determine if the interaction data is associated with a same session as the previously received interaction data to continue interacting with the client device and/or the user thereof. A session may correspond to a time interval over which the client device and/or the user thereof operates the one or more applications and/or webpages. For example, a session may correspond to a time interval in which a user operates an application. The session may terminate when the user ceases to operate the application. The computing device may monitor activity with the one or more applications and/or webpages through the interaction data. If the interaction data is received within a threshold time interval beginning when the last interaction data was received, then the computing device may determine the interaction data to be part of the same session and the process may return to block 512. If the interaction data is received after expiration of the threshold time interval, then the computing device may return to block 508 and generate a revised training dataset that includes the updated training dataset and excludes the portions of the interaction data, the interaction response, and the new interaction data into the training dataset. Removing portions of the interaction data, the interaction response, and the new interaction data into the training dataset may reduce a likelihood of overbiasing the machine-learning model for users that access the application or webpage frequently.

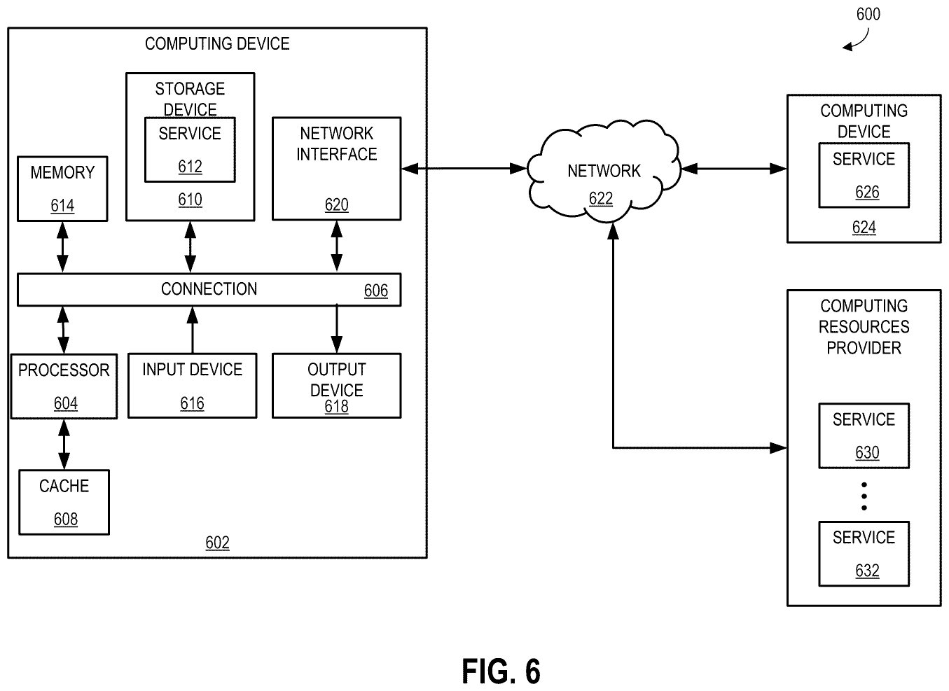

FIG. 6 illustrates a computing system architecture including various components in electrical communication with each other according to aspects of the present disclosure. The example computing system architecture 600 illustrated in FIG. 6 includes a computing device 602, which has various components in electrical communication with each other using connection 606, such as a bus, in accordance with some implementations. The example computing system architecture 600 includes processor 604 that is in electrical communication with various system components, using connection 606, and including memory 614. In some embodiments, memory 614 includes read-only memory (ROM), random-access memory (RAM), and other such memory technologies including, but not limited to, those described herein. In some embodiments, the example computing system architecture 600 includes cache 608 of high-speed memory connected directly with, in close proximity to, or integrated as part of processor 604. The computing system architecture 600 can copy data from memory 614 and/or storage device 610 to cache 608 for quick access by the processor 604. In this way, the cache 608 can provide a performance boost that decreases or eliminates processor delays in the processor 604 due to waiting for data. Using modules, methods and services such as those described herein, the processor 604 can be configured to perform various actions. In some embodiments, cache 608 may include multiple types of cache including, for example, level one (L1) and level two (L2) cache. Memory 614 may be referred to herein as system memory or computer system memory. Memory 614 may include, at various times, elements of an operating system, one or more applications, data associated with the operating system or the one or more applications, or other such data associated with computing device 602.

Other memory can be available for use as well. Memory 614 can include multiple different types of memory with different performance characteristics. The processor 604 can include any general-purpose processor and one or more hardware or software services, such as service 612 stored in storage device 610, configured to control processor 604 as well as a special-purpose processor where software instructions are incorporated into the actual processor design. Processor 604 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, processor 604 can be a microprocessor, a microcontroller, a digital signal processor (“DSP”), or a combination of these and/or other types of processors. In some embodiments, processor 604 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with computing system architecture 600, input device 616 can represent any number of input mechanisms, such as a microphone for speech, a touch-sensitive screen for gesture or graphical input, keyboard, mouse, motion input, pen, and other such input devices. Output device 618 can also be one or more of a number of output mechanisms known to those of skill in the art including, but not limited to, monitors, speakers, printers, haptic devices, and other such output devices. In some instances, multimodal systems can enable a user to provide multiple types of input to communicate with computing system architecture 600. In some embodiments, the input device 616 and/or the output device 618 can be coupled to computing device 602 using a remote connection device such as, for example, a communication interface such as network interface 620 described herein. In such embodiments, the communication interface can govern and manage the input and output received from input device 616 and/or output device 618. As may be contemplated, there is no restriction on operating on any particular hardware arrangement and accordingly the basic features here may easily be substituted for other hardware, software, or firmware arrangements as they are developed.

In some embodiments, storage device 610 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described above, storage device 610 can include hardware and/or software services such as service 612 that can control or configure processor 604 to perform one or more functions including, but not limited to, the methods, processes, functions, systems, and services described herein in various embodiments. In some embodiments, the hardware or software services can be implemented as modules. As illustrated in example computing system architecture 600, storage device 610 can be connected to other parts of computing device 602 using connection 606. In some embodiments, a hardware service or hardware module such as service 612, that performs a function can include a software component stored in a non-transitory computer-readable medium that, in connection with the necessary hardware components, such as processor 604, connection 606, cache 608, storage device 610, memory 614, input device 616, output device 618, and so forth, can carry out the functions such as those described herein.

The disclosed systems and services (e.g., data controller 108 of FIG. 1) can be performed using a computing system such as the example computing system illustrated in FIG. 6, using one or more components of the example computing system architecture 600. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some examples, the processor can be configured to carry out some or all of methods and systems described in connection with the authentication systems described herein by, for example, executing code using a processor such as processor 604 wherein the code is stored in memory such as memory 614 as described herein. One or more of a user device, client device, a provider server or system, a database system, or other such devices, services, or systems may include some or all of the components of the computing system such as the example computing system illustrated in FIG. 6, using one or more components of the example computing system architecture 600 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital representative (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 628. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

Processor 604 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

Memory 614 can be coupled to processor 604 by, for example, a connector such as connection 606, or a bus. As used herein, a connector or bus such as connection 606 is a communications system that transfers data between components within computing device 602 and may, in some embodiments, be used to transfer data between computing devices. Connection 606 can be a data bus, a memory bus, a system bus, or other such data transfer mechanism. Examples of such connectors include, but are not limited to, an industry standard architecture (ISA″ bus, an extended ISA (EISA) bus, a parallel AT attachment (PATA″ bus (e.g., an integrated drive electronics (IDE) or an extended IDE (EIDE) bus), or the various types of parallel component interconnect (PCI) buses (e.g., PCI, PCIe, PCI-104, etc.).

Memory 614 can include RAM including, but not limited to, dynamic RAM (DRAM), static RAM (SRAM), synchronous dynamic RAM (SDRAM), non-volatile random-access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. Memory 614 can also include magnetic or optical data storage media including read-only (e.g., CD ROM and DVD ROM) or otherwise (e.g., CD or DVD). The memory can be local, remote, or distributed.

As described above, the connection 606 (or bus) can also couple processor 604 to storage device 610, which may include non-volatile memory or storage, a drive unit, and/or the like. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 610. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

Connection 606 can also couple the processor 604 to a network interface device such as network interface 620. The interface can include one or more of a modem or other such network interfaces including, but not limited to those described herein. It will be appreciated that the network interface 620 may be considered to be part of computing device 602 or may be separate from computing device 602. Network interface 620 can include one or more of an analog modem, Integrated Services Digital Network (ISDN) modem, cable modem, token ring interface, satellite transmission interface, or other interfaces for coupling a computer system to other computer systems. In some embodiments, network interface 620 can include one or more input and/or output (I/O) devices. The I/O devices can include, by way of example but not limitation, input devices such as input device 616 and/or output devices such as output device 618. For example, network interface 620 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™, SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some examples, computing device 602 can be connected to one or more additional computing devices such as computing device 624 via network 622 using a connection such as network interface 620. In those examples, the computing device 624 may execute one or more services (e.g., service 626, etc.) to perform one or more functions under the control of, or on behalf of, programs and/or services operating on computing device 602. In some examples, a computing device such as computing device 624 may include one or more of the types of components as described in connection with computing device 602 including, but not limited to, a processor such as processor 604, a connection such as connection 606, a cache such as cache 608, a storage device such as storage device 610, memory such as memory 614, an input device such as input device 616, and an output device such as output device 618. In those examples, computing device 624 can carry out the functions such as those described herein in connection with computing device 602. In some examples, the computing device 602 can be connected to a plurality of computing devices such as computing device 624, each of which may also be connected to a plurality of computing devices such as computing device 624. Those examples may be referred to herein as a distributed computing environment.

Network 622 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 622 can be wired connections, wireless connections, or combinations thereof. Communications via the network 622 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over network 622, within computing device 602, within computing device 624, or within computing resources provider 628 can include information, which also may be referred to herein as content. The information may include text, graphics, audio, video, haptics, and/or any other information that can be provided to a user of the computing device such as computing device 602. In some embodiments, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by computing device 602 and presented to a user of the computing device 602 using forms that are perceptible via sight, sound, smell, taste, touch, or other such mechanisms. In some embodiments, communications over network 622 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, computing device 602 and/or computing device 624 can be connected to computing resources provider 628 via network 622 using a network interface such as those described herein (e.g., network interface 620). In such embodiments, one or more systems (e.g., service 630 and service 632) hosted within computing resources provider 628 (also referred to herein as within “a computing resources provider environment”) may execute one or more services to perform one or more functions under the control of, or on behalf of, programs and/or services operating on computing device 602 and/or computing device 624. Systems such as service 630 and service 632 may include one or more computing devices such as those described herein to execute computer code to perform the one or more functions under the control of, or on behalf of, programs and/or services operating on computing device 602 and/or computing device 624.

For example, computing resources provider 628 may provide a service, operating on service 630 to store data for the computing device 602 when, for example, the amount of data that computing device 602 exceeds the capacity of storage device 610. In another example, the computing resources provider 628 may provide a service to first instantiate a virtual machine (VM) on service 632, use that VM to access the data stored on service 632, perform one or more operations on that data, and provide a result of those one or more operations to computing device 602. Such operations (e.g., data storage and VM instantiation) may be referred to herein as operating “in the cloud,” “within a cloud computing environment,” or “within a hosted virtual machine environment,” and computing resources provider 628 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by computing resources provider 628 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, server-less hosting, combinations thereof, or the like. Various techniques to facilitate such services include, but are not limited to, virtual machines, virtual storage, database services, system schedulers (e.g., hypervisors), resource management systems, various types of short-term, mid-term, long-term, and archival storage devices, etc.

As may be contemplated, the systems such as service 630 and service 632 may implement versions of various services (e.g., the service 612 or the service 626) on behalf of, or under the control of, computing device 602 and/or computing device 624. Such implemented versions of various services may involve one or more virtualization techniques so that, for example, it may appear to a user of computing device 602 that service 612 is executing on computing device 602 when the service is executing on, for example, service 630. As may also be contemplated, the various services operating within computing resources provider 628 environment may be distributed among various systems within the environment as well as partially distributed onto computing device 624 and/or computing device 602.

The following examples illustrate various aspects of the present disclosure. As used below, any reference to a series of examples is to be understood as a reference to each of those examples disjunctively (e.g., “Examples 1-4” is to be understood as “Examples 1, 2, 4, or 4”).

Example 1 is a method comprising: receiving interaction data associated with a media element, wherein the interaction data characterizes an instance of interaction between a client device and the media element; generating a training dataset using the interaction data, wherein the training dataset is augmented with characteristics associated with a user identifier associated with the client device; executing a machine-learning model using a feature vector derived from the training dataset, wherein the machine-learning model defines a context associated with the instance of user interaction with the media element and generates an interaction response based on the context, and wherein the interaction response is contextually related to the media element; facilitating a presentation of the interaction response; receiving new interaction data associated with the interaction response, wherein the new interaction data includes an instance of user interaction with the interaction response; executing the machine-learning model using the training dataset and the new interaction data, wherein the machine-learning model defines a new context associated with the instance of user interaction with the interaction response; and updating the training dataset using the new context, wherein updating the training dataset causes a subsequent execution of the machine-learning model to generate a modified media element.

Example 2 is the method of any of example(s) 1 and 3-7, wherein the media element includes at least one of a string, an audio segment, a video segment, or an audiovisual segment.

Example 3 is the method of any of example(s) 1-2 and 4-7, wherein the interaction response includes an automated communication associated with the instance of user interaction with the media element.

Example 4 is the method of any of example(s) 1-4 and 5-7, wherein the interaction response includes a modification to a presentation of the media element.

Example 5 is the method of any of example(s) 1-4 and 6-7, wherein the interaction response includes instructions configured to convert the media element into an interactive media element.

Example 6 is the method of any of example(s) 1-5 and 6, wherein the presentation of the interaction response includes: replacing a portion of a presentation of the media element with the interaction response.

Example 7 is the method of any of example(s) 1-6, further comprising: generating, by the machine-learning model using the updated training dataset, a new media element contextually related to the media element, wherein the new media element is tailored for presentation by the client device.

Example 8 is a system comprising: one or more processors; a non-transitory computer-readable medium storing instructions that when executed by the one or more processors, cause the one or more processors to perform operations including: receiving interaction data associated with a media element, wherein the interaction data characterizes an instance of interaction between a client device and the media element; generating a training dataset using the interaction data, wherein the training dataset is augmented with characteristics associated with a user identifier associated with the client device; executing a machine-learning model using a feature vector derived from the training dataset, wherein the machine-learning model defines a context associated with the instance of user interaction with the media element and generates an interaction response based on the context, and wherein the interaction response is contextually related to the media element; facilitating a presentation of the interaction response; receiving new interaction data associated with the interaction response, wherein the new interaction data includes an instance of user interaction with the interaction response; executing the machine-learning model using the training dataset and the new interaction data, wherein the machine-learning model defines a new context associated with the instance of user interaction with the interaction response; and updating the training dataset using the new context, wherein updating the training dataset causes a subsequent execution of the machine-learning model to generate a modified media element.

Example 9 is the system of any of example(s) 8 and 10-14, wherein the media element includes at least one of a string, an audio segment, a video segment, or an audiovisual segment.

Example 10 is the system of any of example(s) 8-9 and 11-14, wherein the interaction response includes an automated communication associated with the instance of user interaction with the media element.

Example 11 is the system of any of example(s) 8-10 and 12-14, wherein the interaction response includes a modification to a presentation of the media element.

Example 12 is the system of any of example(s) 8-11 and 13-14, wherein the interaction response includes instructions configured to convert the media element into an interactive media element.

Example 13 is the system of any of example(s) 8-12 and 14, wherein the presentation of the interaction response includes: replacing a portion of a presentation of the media element with the interaction response.

Example 14 is the system of any of example(s) 8-13, wherein the operations further include: generating, by the machine-learning model using the updated training dataset, a new media element contextually related to the media element, wherein the new media element is tailored for presentation by the client device.

Example 15 is a non-transitory computer-readable medium storing instructions that when executed by one or more processors, cause the one or more processors to perform operations including: receiving interaction data associated with a media element, wherein the interaction data characterizes an instance of interaction between a client device and the media element; generating a training dataset using the interaction data, wherein the training dataset is augmented with characteristics associated with a user identifier associated with the client device; executing a machine-learning model using a feature vector derived from the training dataset, wherein the machine-learning model defines a context associated with the instance of user interaction with the media element and generates an interaction response based on the context, and wherein the interaction response is contextually related to the media element; facilitating a presentation of the interaction response; receiving new interaction data associated with the interaction response, wherein the new interaction data includes an instance of user interaction with the interaction response; executing the machine-learning model using the training dataset and the new interaction data, wherein the machine-learning model defines a new context associated with the instance of user interaction with the interaction response; and updating the training dataset using the new context, wherein updating the training dataset causes a subsequent execution of the machine-learning model to generate a modified media element.

Example 16 is the non-transitory computer-readable medium of any of example(s) 15 and 17-21, wherein the media element includes at least one of a string, an audio segment, a video segment, or an audiovisual segment.

Example 17 is the non-transitory computer-readable medium of any of example(s) 15-16 and 18-21, wherein the interaction response includes an automated communication associated with the instance of user interaction with the media element.

Example 18 is the non-transitory computer-readable medium of any of example(s) 15-17 and 19-21, wherein the interaction response includes a modification to a presentation of the media element.

Example 19 is the non-transitory computer-readable medium of any of example(s) 15-18 and 20-21, wherein the interaction response includes instructions configured to convert the media element into an interactive media element.

Example 20 is the non-transitory computer-readable medium of any of example(s) 15-19 and 21, wherein the presentation of the interaction response includes: replacing a portion of a presentation of the media element with the interaction response.

Example 21 is the non-transitory computer-readable medium of any of example(s) 15-20, wherein the operations further include: generating, by the machine-learning model using the updated training dataset, a new media element contextually related to the media element, wherein the new media element is tailored for presentation by the client device.

Client devices, computing devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a keypad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 902) include, but is not limited to, desktop computers, laptop computers, server computers, hand-held computers, tablets, smart phones, personal digital representatives, digital home representatives, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein. [0001] Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram (e.g., the example process of FIG. 5). Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, linear classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general-purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital representative (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computing device 602.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 45 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

1. A method comprising:
receiving interaction data associated with a media element, wherein the interaction data characterizes an instance of interaction between a client device and the media element;
generating a training dataset using the interaction data, wherein the training dataset is augmented with characteristics associated with a user identifier associated with the client device;
executing a machine-learning model using a feature vector derived from the training dataset, wherein the machine-learning model defines a context associated with the instance of user interaction with the media element and generates an interaction response based on the context, and wherein the interaction response is contextually related to the media element;
facilitating a presentation of the interaction response;
receiving new interaction data associated with the interaction response, wherein the new interaction data includes an instance of user interaction with the interaction response;
executing the machine-learning model using the training dataset and the new interaction data, wherein the machine-learning model defines a new context associated with the instance of user interaction with the interaction response; and
updating the training dataset using the new context, wherein updating the training dataset causes a subsequent execution of the machine-learning model to generate a modified media element.

2. The method of claim 1, wherein the media element includes at least one of a string, an audio segment, a video segment, or an audiovisual segment.

3. The method of claim 1, wherein the interaction response includes an automated communication associated with the instance of user interaction with the media element.

4. The method of claim 1, wherein the interaction response includes a modification to a presentation of the media element.

5. The method of claim 1, wherein the interaction response includes instructions configured to convert the media element into an interactive media element.

6. The method of claim 1, wherein the presentation of the interaction response includes:
replacing a portion of a presentation of the media element with the interaction response.

7. The method of claim 1, further comprising:
generating, by the machine-learning model using the updated training dataset, a new media element contextually related to the media element, wherein the new media element is tailored for presentation by the client device.

8. A system comprising:
one or more processors; and
a non-transitory computer-readable medium storing instructions that when executed by the one or more processors, cause the one or more processors to perform operations including:
receiving interaction data associated with a media element, wherein the interaction data characterizes an instance of interaction between a client device and the media element;
generating a training dataset using the interaction data, wherein the training dataset is augmented with characteristics associated with a user identifier associated with the client device;
executing a machine-learning model using a feature vector derived from the training dataset, wherein the machine-learning model defines a context associated with the instance of user interaction with the media element and generates an interaction response based on the context, and wherein the interaction response is contextually related to the media element;
facilitating a presentation of the interaction response;
receiving new interaction data associated with the interaction response, wherein the new interaction data includes an instance of user interaction with the interaction response;
executing the machine-learning model using the training dataset and the new interaction data, wherein the machine-learning model defines a new context associated with the instance of user interaction with the interaction response; and
updating the training dataset using the new context, wherein updating the training dataset causes a subsequent execution of the machine-learning model to generate a modified media element.

9. The system of claim 8, wherein the media element includes at least one of a string, an audio segment, a video segment, or an audiovisual segment.

10. The system of claim 8, wherein the interaction response includes an automated communication associated with the instance of user interaction with the media element.

11. The system of claim 8, wherein the interaction response includes a modification to a presentation of the media element.

12. The system of claim 8, wherein the interaction response includes instructions configured to convert the media element into an interactive media.

13. The system of claim 8, wherein the presentation of the interaction response includes:
replacing a portion of a presentation of the media element with the interaction response.

14. The system of claim 8, wherein the operations further include:
generating, by the machine-learning model using the updated training dataset, a new media element contextually related to the media element, wherein the new media element is tailored for presentation by the client device.

15. A non-transitory computer-readable medium storing instructions that when executed by one or more processors, cause the one or more processors to perform operations including:
receiving interaction data associated with a media element, wherein the interaction data characterizes an instance of interaction between a client device and the media element;
generating a training dataset using the interaction data, wherein the training dataset is augmented with characteristics associated with a user identifier associated with the client device;
executing a machine-learning model using a feature vector derived from the training dataset, wherein the machine-learning model defines a context associated with the instance of user interaction with the media element and generates an interaction response based on the context, and wherein the interaction response is contextually related to the media element;
facilitating a presentation of the interaction response;
receiving new interaction data associated with the interaction response, wherein the new interaction data includes an instance of user interaction with the interaction response;
executing the machine-learning model using the training dataset and the new interaction data, wherein the machine-learning model defines a new context associated with the instance of user interaction with the interaction response; and
updating the training dataset using the new context, wherein updating the training dataset causes a subsequent execution of the machine-learning model to generate a modified media element.

16. The non-transitory computer-readable medium of claim 15, wherein the media element includes a string, an audio segment, a video segment, or an audiovisual segment.

17. The non-transitory computer-readable medium of claim 15, wherein the interaction response includes an automated communication associated with the instance of user interaction with the media element.

18. The non-transitory computer-readable medium of claim 15, wherein the interaction response includes a modification to a presentation of the media element.

19. The non-transitory computer-readable medium of claim 15, wherein the interaction response includes instructions configured to convert the media element into an interactive media element.

20. The non-transitory computer-readable medium of claim 15, wherein the presentation of the interaction response includes:
replacing a portion of a presentation of the media element with the interaction response.
